(19) United States
(12) Patent Application Publication
(10) Pub. No.: US 2008/0173608 A1
(43) Pub. Date: Jul. 24, 2008

(54) Feeding container venting apparatus and methods

(76) Inventor: Avery C. Johnson, Denver, CO (US)

Correspondence Address: HAROLD A. BURDICK, 6676 Gunpark Drive, Suite E, Boulder, CO, 80301, US

(21) Appl. No.: 11/656,903

(22) Filed: Jan. 24, 2007

(51) Int. Cl. A61J 9/04; B23P 19/02

(52) U.S. Cl. 215/11.5; 29/426.4

(57) ABSTRACT

Feeding container venting apparatus and methods are disclosed. A vent structure is mounted through an opening formed in a feeding container adjacent to its fill port and includes a pliable protrusion extending from an inner diameter of an annular rim. The protrusion has a hollow interior, a ported end at the rim and a distal end having a slit thereat allowing communication with the hollow interior. The pliable protrusion is pressed through the container opening to reside interior of the container adjacent to the container fill port with the rim abutting the exterior of the container. A spacer is located at the rim with a portion spaced axially from the inner diameter of the rim to prevent inadvertent blockage of air flow to the hollow interior of the protrusion, and a membrane extends partially across the inner diameter of the rim to inhibit fluid leakage from the hollow interior of the protrusion. A cutting tool for retrofitting feeding containers is also disclosed.

### FIELD OF THE INVENTION

This invention relates to juvenile feeding containers such as baby bottles, and, more particularly, relates to feeding container venting apparatus and methods.

### BACKGROUND OF THE INVENTION

Standard feeding containers for children and/or juvenile (including injured) animals are typically constructed with a rigid or semi-rigid container capped by a pliable feeding nipple and installation ring (threaded typically). Such construction results in a sealed container except for the outlet hole at the nipple tip. During feeding, the container is positioned (usually inverted) so that the contained liquid material is received at the end of the container having the nipple thereat, allowing withdrawal of the material by suckling at the nipple through the outlet hole at the nipple tip. One consequence of this construction, as is known, is that a partial vacuum develops within the container during feeding as the user withdraws the liquid material from the container. To avoid difficulty during continued feeding, this vacuum must be periodically relieved, typically by a cessation of feeding and repositioning of the container to allow entry of air through the hole at the nipple tip to restore equilibrium within the container.

Various vented feeding containers have been heretofore suggested and/or utilized to alleviate the problem of vacuum formation within the container during feeding (see U.S. Pat. Nos. 2,321,236, 3,134,495, 5,699,921, 5,797,505, 5,944,205, and 6,601,720). These heretofore suggested solutions have all suffered to some extent from problems related to leakage, blockage (either by a user from the outside or by the dispensed material from the inside), undue complexity and thus expense, and/or difficulty in application, use and reuse. Because vacuum formation during feeding disrupts the feeding process and/or results in waste of unused contained materials occasioned by material foaming and difficulty of withdrawal of the final quantity of materials in the container, resolution of the problems encountered by previously known vented feeding containers would thus still be beneficial.

### SUMMARY OF THE INVENTION

This invention provides improved feeding containers and methods for dispensing flowable materials, and improved venting apparatus and methods for alleviation of vacuum formation within such a feeding container during feeding. The feeding container venting apparatus and methods provided alleviate feeding disruption and waste of unused contained materials occasioned by material foaming and difficulty of withdrawal of the final quantity of materials in the container, and minimize container content leakage and flow blockage (either by a user from the outside or by the dispensed material from the inside). The apparatus of this invention are simple and inexpensive to produce, and are easy to apply, use and reuse.

The venting apparatus includes an annular rim having an inner diameter and an outer border (preferably having a diameter), and a pliable protrusion having a hollow interior. A ported, or open, end of the protrusion extends from the inner diameter of the rim, and a distal end is spaced from the open end with a yieldable access allowing communication therethrough with the hollow interior. The feeding container is provided with an opening for mounting of the venting apparatus, the opening formed in the container adjacent to a fill port of the container (typically located at the top of the container for receipt of the feeding nipple thereat).

The annular rim has first and second oppositely facing surfaces, a spacer positioned at the first oppositely facing surface with a portion of the spacer spaced axially from the inner diameter of the rim. A membrane is preferably positioned part way across the inner diameter of the rim. The pliable protrusion preferably has a diameter at the ported end substantially equivalent to the inner diameter of the annular rim and extends from the rim at the second oppositely facing surface. The pliable protrusion is thus mountable through the container opening to reside interior of the container adjacent to the container fill port with the rim abutting the exterior of the container.

The venting apparatus of this invention further includes a cutting tool for retrofitting feeding containers. The tool includes a cut position locator and stabilizer held within a retractable shroud and an arcuate blade, both of which are associated with a manipulable shaft for forming the opening in the container. The arcuate blade has a diameter selected so that the pliable protrusion is held firmly and sealably through the opening.

The method of this invention includes the steps of cutting an opening in the container at a position adjacent to the top fill port of the container and pressing a hollow pliable protrusion having a yieldable access at one end thereof into the opening so that the end extends well into the container. At least one guard is established at the opening to the container adjacent to the pliable protrusion to inhibit fluid leakage from the container and blockage of air movement into the hollow protrusion.

It is therefore an object of this invention to provide improved feeding container venting apparatus and methods.

It is another object of this invention to provide improved feeding container apparatus and methods for alleviation of vacuum formation within the container during feeding.

It is still another object of this invention to provide improved feeding container venting apparatus and methods that alleviate feeding disruption and waste of unused contained materials occasioned by material foaming and difficulty of withdrawal of the final quantity of materials in the container.

It is yet another object of this invention to provide feeding container venting apparatus and methods that minimize container content leakage and flow blockage (either by a user from the outside or by the dispensed material from the inside).

It is another object of this invention to provide feeding container venting apparatus and methods that are simple and inexpensive to produce and that are easy to apply, use and reuse.

It is still another object of this invention to provide a feeding container venting apparatus that includes an annular rim having an inner diameter and an outer diameter, and a pliable protrusion having a hollow interior, an open end extending from the inner diameter of the rim, and a distal end spaced from the open end with a yieldable access allowing communication therethrough with the hollow interior.

It is still another object of this invention to provide a feeding container venting apparatus for mounting through an opening formed in the container adjacent to a fill port of the container, the venting apparatus including an annular rim having an inner diameter, an outer rim border, first and second oppositely facing surfaces, and a spacer positioned at the first oppositely facing surface with a portion of the spacer spaced axially from the inner diameter, and a pliable protrusion having a hollow interior, a ported end having a diameter substantially equivalent to the inner diameter of the annular rim and extending from the inner diameter of the rim at the second oppositely facing surface, and a distal end spaced from the ported end with a yieldable access allowing communication therethrough with the hollow interior, the pliable protrusion mountable through the container opening to reside interior of the container adjacent to the container fill port with the rim abutting the exterior of the container.

It is yet another object of this invention to provide a feeding container venting apparatus that includes a cutting tool having a cut position locator and stabilizer and an arcuate blade both associated with a manipulable shaft for forming a opening in the container with a diameter selected so that a pliable vent is held firmly and sealably through the opening.

It is yet another object of this invention to provide a method for adapting a feeding container to vent the container during feeding, the container including a nipple mountable at a top fill port of the container, the method including the steps of cutting an opening in the container at a position adjacent to the top fill port of the container, pressing a hollow pliable protrusion having a yieldable access at one end thereof into the opening so the one end extends well into the container, and establishing at least one guard at the opening to the container adjacent to the pliable protrusion thereat to inhibit fluid leakage from the container and blockage of air movement into the hollow protrusion from outside the container.

With these and other objects in view, which will become apparent to one skilled in the art as the description proceeds, this invention resides in the novel construction, combination, and arrangement of parts and methods substantially as hereinafter described, and more particularly defined by the appended claims, it being understood that changes in the precise embodiment of the herein disclosed invention are meant to be included as come within the scope of the claims.

### BRIEF DESCRIPTION OF THE DRAWINGS

The accompanying drawings illustrate a complete embodiment of the invention according to the best mode so far devised for the practical application of the principles thereof, and in which:

FIG. 1 is a partial perspective view of an assembled feeding container showing the venting of this invention installed therewith;

FIG. 2 is a perspective view of the venting of this invention;

FIG. 3 is another perspective view of the venting of this invention;

FIG. 4 is a perspective view of the cutting tool used for vent installation of this invention; and

FIG. 5 is an exploded view of the cutting tool shown in FIG. 4.

### DESCRIPTION OF THE INVENTION

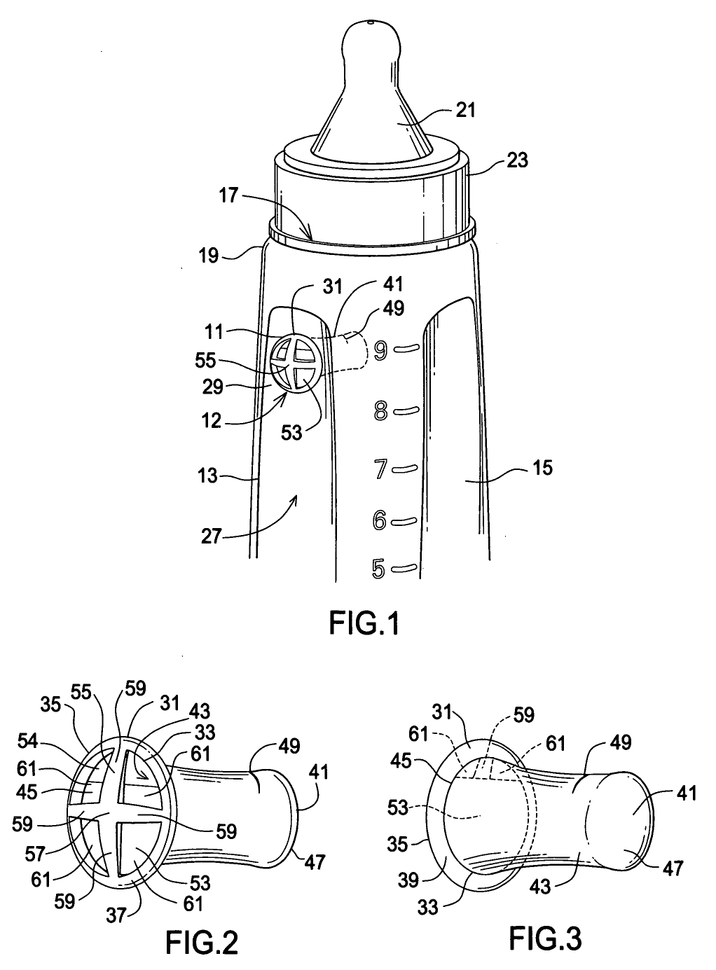

The venting apparatus of this invention includes vent structure 11 installed in an opening 12 made in feeding container assembly 13 as shown in FIG. 1. A standard feeding container assembly typically includes a container 15 having fill port 17 at top part 19 thereof. A feeding nipple 21 is installed at fill port 17, by use of a retaining ring 23 engageable at threaded neck (not shown) for example, or other known construction. Container 15 has an interior fluid receiving volume 27 and exterior surface 29. Opening 12 is formed of a precise size to accommodate vent structure 11 in a firm, sealing interrelationship when vent structure 11 in pressed into place.

Vent structure 11 may be made of multiple connected components, but is preferably a unified structure (molded, for example) made of a single pliable material (of any of the types utilized in the manufacture of liquid food-safe containers), and is preferably made of pliable plastic of the type utilized to make feeding nipples. As shown in FIGS. 1 through 3, vent structure 11 includes annular rim 31 having inner diameter 33, outer rim border 35 (preferably annular having a diameter, though any shape could be formed and utilized), and oppositely facing surfaces 37 and 39.

An elongated pliable protrusion 41 having a hollow interior 43 extends at ported open end 45 from inner diameter 33 at surface 39 of rim 31. Distal end 47 is spaced from open end 45 a selected distance sufficient to extend well into interior volume 27 adjacent fill port 17 of container 15 when structure 11 is pressed into opening 12 of container 15. Yieldable access slit 49 is positioned between ends 45 and 47 (but at end 47, relatively), and acts as a valve allowing communication with interior volume 27 from hollow interior 43 of protrusion 41. In this way, air is allowed to enter container 15 during feeding to relieve any interior vacuum built up during the feeding process, while inhibiting passage of substantial amounts of fluid therethrough into hollow interior 43.

While a circumferential slit 49 is preferred, various other slit orientations, configurations, and locations relative to end 47 of protrusion 41 can be utilized (for example, orienting the slit axially, configuring the slit arcuately, repositioning the slit radially, or locating the slit nearer end 47). To prevent leakage or dripping of any fluid that may accumulate in hollow interior 43 of protrusion 41 during feeding, leak guard 53 (preferably a thin pliable membrane barrier) is located part way across inner diameter 33 of rim 31. Guard 53 covers a substantial area of inner diameter 33, preferably leaving only a single gap 54 adjacent inner diameter 33 for passage of air. When installing structure 11 at opening 12, orientation of guard 53 can be selected to best inhibit any possibility of leakage of accumulated fluid at hollow interior 43 of protrusion 41 that may have escaped interior volume 27 of container 15 through slit 49.

Another guard 55 is located adjacent to surface 37 of rim 31. This guard serves to inhibit blockage of ported open end 45 of protrusion 41 during feeding by those utilizing the apparatus of this invention, essentially functioning as a spacer over inner diameter 33 of rim 31. Guard 55 is arched so that central portion 57 is spaced axially from inner diameter 33 of rim 31. Plural legs 59 extend from central portion 57 and merge with rim 31 between inner and outer diameter 33 and 35, respectfully, at their termini. Such structure establishes plural air passageways 61 opening to inner diameter 33 of rim 31 and thus hollow interior 43 of protrusion 41. Because central portion 57 is raised relative to exterior surface 29 of container 15 (after vent 11 installation) and relative to inner diameter 33, it is difficult for users to inadvertently totally block passage of air through to hollow interior 43 (and thus inadvertently disable vent structure 11 thereby allowing vacuum build-up within container assembly 13).

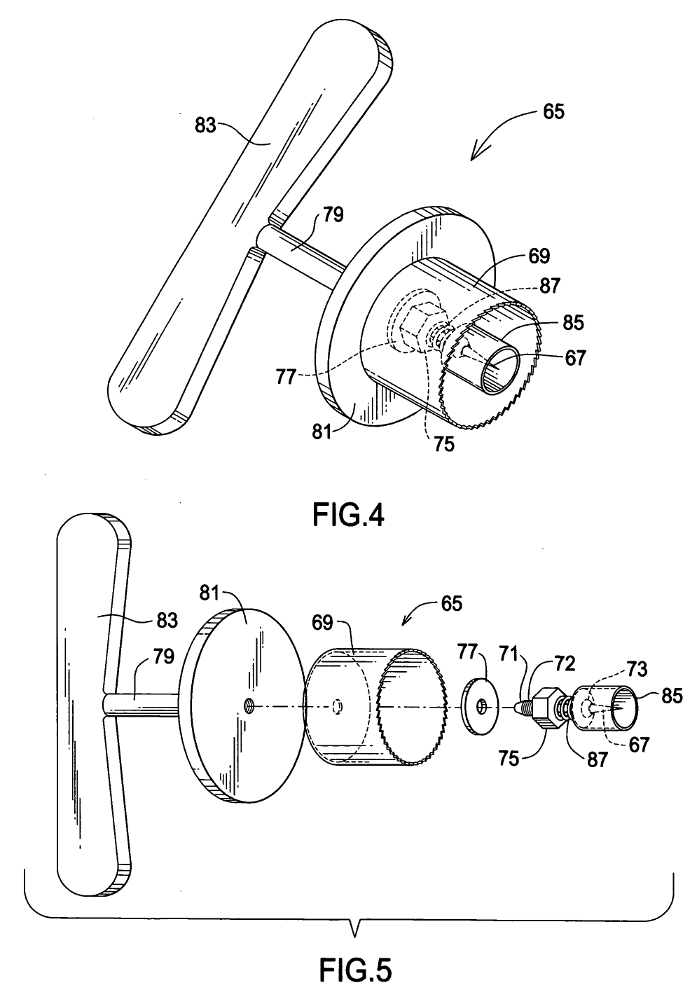

Turning now to FIGS. 4 and 5, cutting tool 65 of the venting apparatus of this invention is shown. Tool 65 includes a cut position locating and stabilizing point guide 67 (a puncturing awl or the like) and arcuate hole cutting blade 69 both connected with manipulable shaft 71 having a threaded end 72. Guide 67 may be attached to or formed at the end of shaft 71, and has stop surface 73 located thereat. Mounting nut and washer 75 and 77, respectively, are mounted on shaft 71 and bear against blade 69 when threaded end 72 of shaft 71 is mounted in handle 79. Handle 79 includes blade bearing surface 81 and hand grip 83 at opposite ends thereof.

Retractable safety shroud 85 is movable against bias of spring 87 held on shaft 71 between stop surface 73 and nut 75 when pressed against a surface. Point guide 67 is thus only exposed when shroud 85 is placed against the exterior surface 29 of a container 15. Once properly located, guide 67 actually pierces container 15, allowing contact of blade 69 with surface 29 of container 15 as pressure continues to be applied and stabilizing tool 65 during use. Rotation of handle 79 using grip 83 rotates blade 69, thereby cutting opening 12 in container 15.

Blade 69 and protrusion 41 are matched in size (circumferences at their final engagement locations) so that when vent structure 11 is pressed into opening 12 in container 15 with surface 39 of rim 31 abutting exterior surface 29 of container 15 a seal is established between opening 12 and pliable protrusion 41. In this way, leakage around structure 11 is simply prevented. As may be appreciated, provision of means to cut opening 12 allows retrofitting of container assemblies that a user may already possess. Such may be provided in kit form with tool 65 and vent structures 11 sold together.

As may be appreciated from the foregoing, this invention may take many forms including preassembled units having both container assembly and vent structure, separate units wherein a precut container assembly is provided and vent structures are separately provided, and retrofitting kits as described above. In all cases, the vent structure is readily disengagable from and reengagable with the container assembly to allow washing/disinfecting and reuse.

What is claimed is:

1. A feeding container venting apparatus comprising:
an annular rim having an inner diameter and an outer diameter; and
a pliable protrusion having a hollow interior, an open end extending from said inner diameter of said rim, and a distal end spaced from said open end with a yieldable access allowing communication therethrough with said hollow interior.

2. The venting apparatus of claim 1 further comprising a fluid leakage barrier positioned at said inner diameter of said annular rim.

3. The venting apparatus of claim 1 further comprising an arched guard over said inner diameter of said rim opposite said protrusion.

4. The venting apparatus of claim 3 wherein said arched guard defines plural air passageways entering said hollow interior of said protrusion.

5. The venting apparatus of claim 3 wherein said arched guard merges with said rim between said inner diameter and said outer diameter and includes a central portion spaced axially from said inner diameter.

6. The venting apparatus of claim 1 wherein said rim and said protrusion are a unified structure made of a pliable material, and wherein said yieldable access of said pliable protrusion is a slit.

7. The venting apparatus of claim 1 further comprising a feeding container with an interior volume and an exterior surface and having an opening formed in said container adjacent to a fill port of said container, a feeding nipple mountable at said fill port, said pliable protrusion pressed into said opening in said container with said rim abutting said exterior surface of said container.

8. A feeding container venting apparatus for mounting through an opening formed in the container adjacent to a fill port of the container, said venting apparatus comprising:
an annular rim having an inner diameter, an outer rim border, first and second oppositely facing surfaces, and a spacer positioned at said first oppositely facing surface with a portion of said spacer spaced axially from said inner diameter; and
a pliable protrusion having a hollow interior, a ported end having a diameter substantially equivalent to said inner diameter of said annular rim and extending from said inner diameter of said rim at said second oppositely facing surface, and a distal end spaced from said ported end with a yieldable access allowing communication therethrough with said hollow interior, said pliable protrusion mountable through the container opening to reside interior of the container adjacent to the container fill port with said rim abutting the exterior of the container.

9. The venting apparatus of claim 8 further comprising a pliable membrane extending part way across said inner diameter of said rim.

10. The venting apparatus of claim 9 wherein the container fill port is located at a top part of the container and receives a feeding nipple thereat, said annular rim, said pliable protrusion, and said membrane comprising a unified structure made of a pliable material.

11. The venting apparatus of claim 8 wherein said spacer of said rim is configured to establish plural openings to said inner diameter of said rim.

12. The venting apparatus of claim 8 wherein said yieldable access at said distal end of said pliable protrusion is a circumferential slit.

13. The venting apparatus of claim 8 further comprising a cutting tool including a cut position locator and stabilizer and an arcuate blade both associated with a manipulable shaft for forming the opening in the container, said arcuate blade having a diameter selected so that said pliable protrusion is held firmly and sealably through the opening.

14. A method for adapting a feeding container to vent the container during feeding, the container including a nipple mountable at a top fill port of the container, said method comprising the steps of:
cutting an opening in the container at a position adjacent to the top fill port of the container;
pressing a hollow pliable protrusion having a yieldable access at one end thereof into the opening so the one end extends well into the container; and
establishing at least one guard at the opening to the container adjacent to the pliable protrusion thereat to inhibit fluid leakage from the container and blockage of air movement into the hollow protrusion from outside the container.

15. The method of claim 14 wherein the step of cutting an opening includes sizing the container opening so that a sealed mounting is established when the protrusion is pressed into the container opening.

16. The method of claim 14 wherein the step of establishing at least one guard further comprises establishing first and second guards.

17. The method of claim 16 wherein the protrusion includes a ported end opposite the one end, the step of establishing first and second guards further comprising arching the first guard over the ported end of the protrusion.

18. The method of claim 16 wherein the protrusion includes a ported end opposite the one end, the step of establishing first and second guards further comprising extending the second guard part way across the ported end of the protrusion.

19. The method of claim 14 further comprising the step of circumferentially slitting the protrusion adjacent to the one end to establish the yieldable access.

20. The method of claim 14 wherein the protrusion includes a ported end opposite the one end, said method further comprising the step of configuring the protrusion with a rim at the ported end that is larger than the opening in the container.
